(19) United States
(12) Patent Application Publication
(10) Pub. No.: US 2025/0162377 A1
(43) Pub. Date: May 22, 2025

(54) HEATING, VENTILATION, AIR CONDITIONING (HVAC) CONTROL SYSTEM TO TURN ON THE HVAC SYSTEM BASED ON CLIMATE CONDITIONS AND TO REMOTE START THE VEHICLE WITH THE HVAC SYSTEM ON

(71) Applicant: FCA US LLC, Auburn Hills, MI (US)

(72) Inventor: Pavin Lakshmipathi, Rochester Hills, MI (US)

(21) Appl. No.: 18/513,751

(22) Filed: Nov. 20, 2023

(51) Int. Cl. B60H 1/00

(52) U.S. Cl. CPC B60H 1/00064; B60H 2001/0015

(57) ABSTRACT

A vehicle system and method for determining an internal temperature of the vehicle prior to a predetermined event and comparing the internal temperature to a predetermined temperature range. If the internal temperature is not within the preferred internal temperature range the system notifies a user and allows the user to authorize the system to remote start the vehicle and/or turn on the heating, ventilation and air conditioning (HVAC) system to adjust the internal temperature to be within the preferred internal temperature range.

### FIELD

The present disclosure relates to a system and method to allow a user to turn on a vehicle HVAC system remotely and to remote start a vehicle with the HVAC system on.

### BACKGROUND

The external temperature around a vehicle can change the internal vehicle temperature. It is uncomfortable for a user when the user enters a vehicle to use it and the interior temperature of a vehicle is either too hot or too cold. Under either of these conditions it can take a significant period of time after a vehicle is started for the vehicle heating, ventilation, and air conditioning (HVAC) system to bring the interior temperature of the vehicle into a preferred temperature range.

### SUMMARY

In at least some implementations, a method of remotely adjusting a vehicle internal temperature using a vehicle heating, ventilation, and air conditioning (HVAC) system includes determining an occurrence of an initiating event, determining an internal temperature of a vehicle, sending a notification to a user when the internal temperature is outside of a predetermined temperature range, requesting authorization from the user to activate the HVAC system when the internal temperature is outside of the predetermined temperature range, and activating the HVAC system upon receipt of a user instruction to activate the HVAC system.

In at least some implementations, the method also includes starting the vehicle after receipt of the user instruction.

In at least some implementations, the initiating event is provided by a user. In at least some implementations, the initiating event is determined by a control system based upon use of the vehicle. In at least some implementations, the initiating event includes an event offset time of at least 5 minutes.

In at least some implementations, the method also includes tracking use of the vehicle with respect to time of day, day of week and vehicle location to determine one or more user habits or routines with regards to vehicle use. In at least some implementations, the notification includes information relating to the initiating event.

In at least some implementations, the method also includes redetermining the internal temperature after some time period after the activating step.

In at least some implementations, the method includes providing at least one temperature sensor and a vehicle telematic unit, and wherein the step of determining the internal temperature is accomplished by querying the at least one temperature sensor, and wherein the notification and receipt steps are accomplished with the telematic unit.

In at least some implementations, the method includes providing at least one temperature sensor, a vehicle telematic unit, and a remote start module, and wherein the step of determining the internal temperature is accomplished by querying the at least one temperature sensor, and wherein the notification and receipt steps are accomplished with the telematic unit, and wherein the step of starting the vehicle is accomplished by the remote start module.

In at least some implementations, the method also includes receiving and storing user provided information relating to one or more initiating events. In at least some implementations, the method also includes providing a user interface for a vehicle infotainment system, and wherein the receiving step is accomplished via the user interface.

In at least some implementations, the method also includes determining if the vehicle is in a park mode, and wherein the notification is not sent if the vehicle is not in the park mode.

In at least some implementations, the predetermined temperature range is between 65 to 75° F., inclusive.

In at least some implementations, a vehicle heating, ventilation and air conditioning (HVAC) control system includes a vehicle infotainment system electronic control unit (ECU) and a user interface connected to it, at least one temperature sensor connected to the infotainment system, a vehicle radio telematic control unit ECU connected to the infotainment system and configured to communicate with a user mobile phone, a vehicle HVAC system ECU connected to the radio telematic control unit ECU and to a vehicle HVAC system, a remote start module and ECU connected to the radio telematic control unit ECU and to the vehicle HVAC system ECU, a vehicle transmission ECU connected to the infotainment system ECU, and wherein the radio telematic control unit ECU is configured to communicate with a user mobile phone over a cellular network or WiFi and wherein the user mobile phone can direct the radio telematic control unit ECU to send a signal to the remote start module and ECU to start the vehicle and to send a signal to the vehicle HVAC system ECU to turn on the vehicle HVAC system.

In at least some implementations, the vehicle transmission ECU provides an indication to the HVAC control system when the vehicle transmission is not in park. In at least some implementations, the HVAC control system is disabled when the vehicle transmission is not in park. In at least some implementations, the at least one temperature sensor communicates an internal temperature of the vehicle to the infotainment system.

In at least some implementations, a vehicle heating, ventilation and air conditioning (HVAC) control system includes a vehicle infotainment system including a user interface, at least one temperature sensor connected to the infotainment system, a vehicle telematic unit connected to the infotainment system and configured to communicate with a user mobile phone, a vehicle HVAC system connected to the telematic unit, a remote start module connected to the telematic unit and to the vehicle HVAC system, and a vehicle transmission controller connected to the infotainment system. The telematic unit is configured to wirelessly communicate with a user mobile phone to enable control of the remote start module to start the vehicle, and to control the vehicle HVAC system to turn on the vehicle HVAC system.

In at least some implementations, the vehicle transmission controller provides an output when the vehicle is not in a park mode to prevent actuation of the remote start module and remote actuation of the HVAC system via instructions received at the telematics unit.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic diagram showing the major components of an HVAC control system according to the present disclosure;

FIG. 2A is a first part of a flow diagram of the method according to the present disclosure;

FIG. 2B is a continuation of the flow diagram of FIG. 2A of the method according to the present disclosure;

FIG. 2C is a continuation of the flow diagram of FIG. 2B of the method according to the present disclosure; and

FIG. 3 is a flow diagram of a method for remote operation of a vehicle HVAC system.

### DETAILED DESCRIPTION

The present disclosure is directed to a system and a method for, among other things, notifying a user that the interior temperature of a vehicle is outside of a preferred temperature range before a user enters the vehicle to allow the user to remote start the vehicle and/or have the HVAC system operate to either cool or heat the vehicle for a period of time so that when the user actually goes to use the vehicle the interior temperature will be in the preferred temperature range of the user. When a vehicle is exposed to high exterior temperature the interior temperature of the vehicle can rise to an uncomfortable level, similarly exposure to low exterior temperatures can lower the interior temperature of the vehicle to an uncomfortable range. Many users have a daily or weekly routine wherein the vehicle is used at the same times each day or at the same times on certain days. It would be convenient for a user if they could be notified of the internal temperature of the vehicle when the time approaches a pre-entered vehicle use time and then turn on the vehicle and the HVAC system to either heat up the interior or cool it down as needed prior to the time when they actually need to use the vehicle.

In the present specification and claims the term electronic control unit is abbreviated ECU. The present system requires the interaction of numerous vehicle systems in addition to a vehicle application that a user downloads to their mobile device, the vehicle app. The user downloads it to their mobile device and links it to a specific vehicle. The vehicle app is commonly used by the manufacturer to send messages to the consumer regarding their vehicle such as vehicle maintenance messages, vehicle status updates, and advertisement offers. The disclosed system uses a vehicle infotainment system as a hub for control of the system. The vehicle infotainment system is connected to a range of other vehicle systems as described herein below. Modern vehicles include a radio telematic control unit ECU that interacts with vehicle systems and can engage in two-way communication over a cellular network or via WiFi with, for example, a manufacturer, with the vehicle app, and with a user's mobile device. The vehicle radio telematic control unit ECU is utilized in the present disclosed system. Other vehicle systems that are utilized in the disclosed system include: both external and internal temperature sensors, a vehicle HVAC system ECU and the vehicle HVAC system, a vehicle transmission ECU, and a vehicle remote start module and ECU. A user interface with the infotainment system ECU allows for a user to enter information into the infotainment system ECU to be used in the disclosed system.

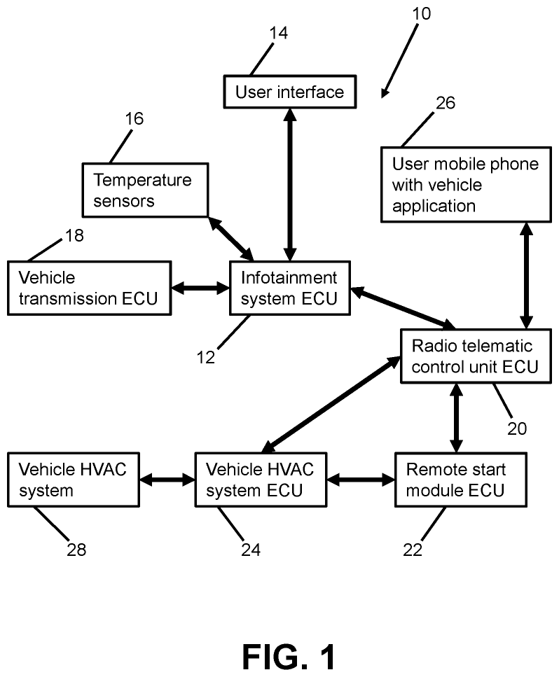

Referring in more detail to the drawings, FIG. 1 is a schematic diagram showing the major components of an HVAC control system 10 according to the present disclosure. A vehicle infotainment system ECU 12 can be interacted with by a consumer through a user interface 14. The user interface 14 permits a user to enter data into the infotainment system ECU 12 and to control the HVAC control system 10. The infotainment system ECU 12 includes a time and date keeping function and keeps track of the current time and date for the location of the vehicle. Another portion of the infotainment system ECU 12 is the vehicle navigation and tracking functions. The infotainment system ECU 12 is connected to and receives data from one or more temperature sensors 16. These temperature sensors 16 provide both an external temperature reading and an internal temperature reading to the infotainment system ECU 12 when queried by the infotainment system ECU 12. The infotainment system ECU 12 is also connected to a vehicle transmission ECU 18. The disclosed HVAC control system 10 only functions when the vehicle transmission is in park, if the vehicle transmission is moved out of park the disclosed HVAC control system 10 disengages from control of the HVAC system ECU 24. The infotainment system ECU 12 also is connected to a radio telematic control unit ECU 20 in the vehicle. The radio telematic control unit ECU 20 can interact via two-way communication with a user mobile phone 26 having the vehicle app on it via a cellular network or WiFi. The radio telematic control unit ECU 20 is also connected to a remote start module ECU 22 which is connected to an HVAC system ECU 24 of the vehicle. The radio telematic control unit ECU 20 is also connected to the vehicle HVAC system ECU 24. The vehicle HVAC system ECU 24 is connected to the vehicle HVAC system 28 and controls it.

Prior to use of the HVAC control system 10 a user must enter certain data into the infotainment system ECU 12 via the user interface 14. The user must provide the mobile phone number of the mobile phone 26 with the vehicle app. The user must also enter a preferred predetermined temperature range that the user wants during use of the vehicle. For most users this will range from 65 to 75° F. (18-24° C.), however, the user can set any desired preferred predetermined temperature range. The user then proceeds to enter a plurality of events each comprised of an event time and an event day(s) of the week when the vehicle is expected to be used. For example, the user can enter an event having an event time of 7:30 am on the event days of Monday through Friday, which may be when the user leaves for work. The user may also enter an event having an event time of 5:00 pm on the event days of Monday through Friday, which may be when the user leaves work for home. The user might enter an event time of 10:00 am on the event days of Monday, Wednesday, and Friday, which might be when they leave to go to the gym. The user continues to enter events comprised of an event time and an event day(s) of the week until they have entered the desired number of events. Each event can be given an event name by the user in the user interface 14, for example, “work” or “leave for work”. The user also needs to select an event offset time of X number of minutes, for example at least 5 minutes, either for each event individually or for all of the preset events. The event offset time, event time and event day are used by the HVAC control system 10 to determine when it initiates its program logic as described herein. For example, if the event offset time was set to 15 minutes, then 15 minutes prior to a scheduled event the HVAC control system 10 would run through the program logic to determine if it was necessary to run the HVAC system to bring the interior temperature of the vehicle into the preferred predetermined temperature range as set by the user.

In the alternative, rather than having a user enter all of the events when the vehicle is expected to be used the HVAC control system 10 can be set to a learn mode for a user selected period of time through the user interface 14. During the learn mode period of time the Infotainment system ECU 12 and HVAC control system 10 record each event when the vehicle is used, recording the event time and event day of the week. After the learn mode period of time the user is prompted to review the plurality of “learned” events and can either confirm all or part of the learned events, modify each event, and/or add events as desired. By either process, the user has entered into the HVAC control system 10 a plurality of events representing when the vehicle is routinely expected to be used during the 7 days of the week. The review and confirmation of the plurality of events can either be done through the user interface 14 or the infotainment system ECU 12 can use the radio telematic control unit ECU 20 to send to the user mobile phone 26 with the vehicle app on it the list of the events and request confirmation, addition, or modification of the listed events via the vehicle app.

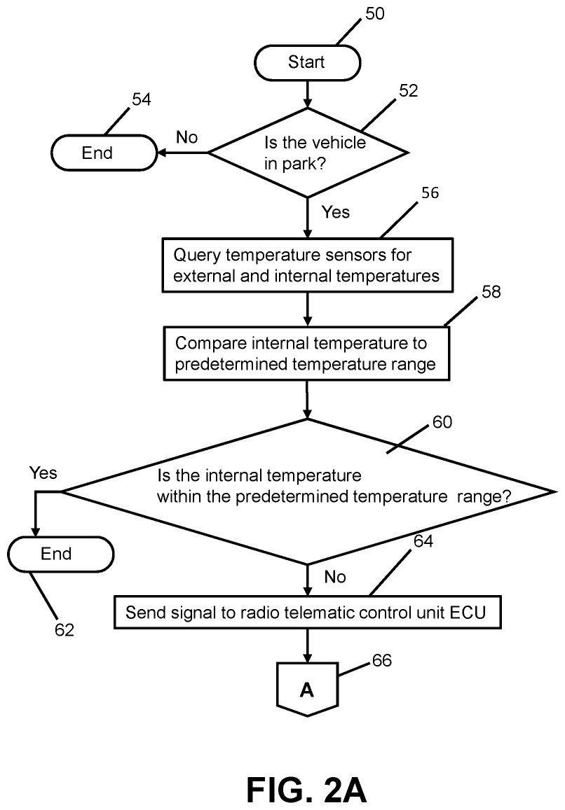

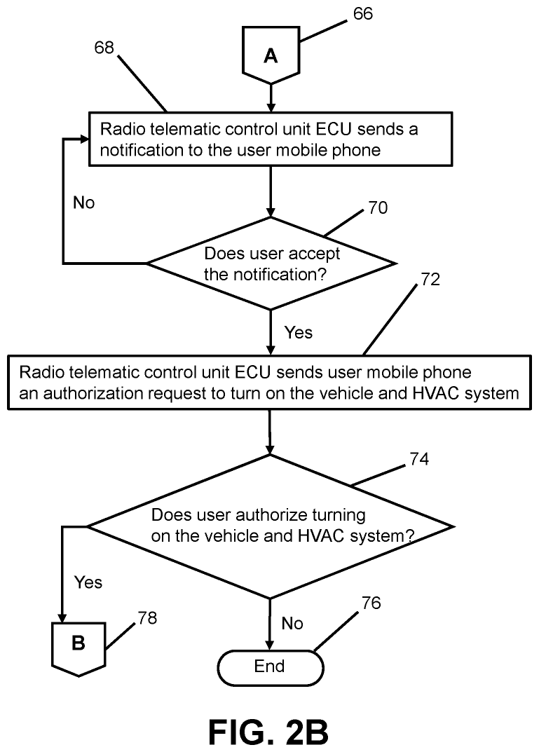

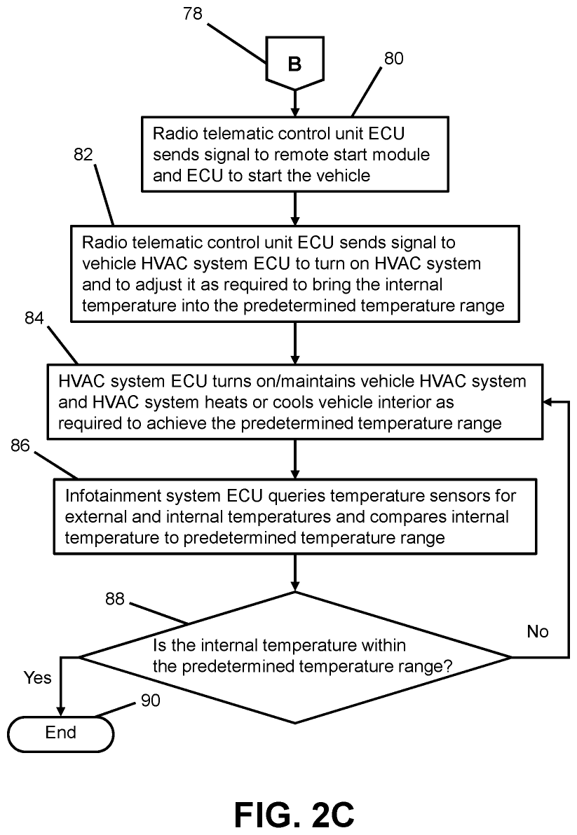

Once a plurality of events have been entered into the HVAC control system 10 and the other key data has been entered as described above, the HVAC control system 10 can be utilized. The logic and use of the HVAC control system 10 will now be described in an example and with reference to FIG. 2A to 2C. In this example the event has an event time of 7:00 am and event day(s) of Monday through Friday, the preferred temperature range is set to 65 to 70° F. and the event offset time is set to 15 minutes. On Monday through Friday, at 6:45 am the HVAC control system 10 runs the logic program from a start step 50. First, the infotainment system ECU 12 will query the vehicle transmission ECU 18 to determine if the vehicle transmission is in park in step 52. If the vehicle transmission is not in park then in step 54 the HVAC control system 10 program ends until the next scheduled event. If the vehicle transmission is in park in step 52 then the infotainment system ECU 12 queries the temperature sensors 16 to provide the external temperature and the internal vehicle temperature in step 56. The infotainment system ECU 12 compares the internal temperature to the preferred predetermined temperature range in step 58. If the internal temperature is within the preferred predetermined temperature range in step 60 then the HVAC control system 10 moves to step 62 and ends. If the internal temperature is not within the preferred predetermined temperature range in step 60 then the HVAC control system 10 moves to step 64 and the infotainment system ECU 12 sends a signal to the radio telematic control unit ECU. Box 66 in FIG. 2A designates that the program continues in FIG. 2B at box 66.

As shown in FIG. 2B, in step 68 after receiving the signal from the infotainment system ECU 12 the radio telematic control unit ECU 20 sends a notification to the user mobile phone 26 using the phone number entered by the user in the user interface 14. This mobile phone 26 has loaded onto it the vehicle app, which is connected to the user's vehicle. The notification will alert the user that the internal temperature is not within the preferred predetermined temperature range. The notification can also be structured to provide additional information as desired via changes through the user interface 14. For example, it might provide the name of the event, the actual internal temperature of the vehicle and other useful information. The radio telematic control unit ECU 20 will continue to send the notification to the user mobile phone 26 until the user accepts the notification in step 70 or the number of ignored notifications reaches a certain number, either a default predetermined number or a user selected predetermined number. For example, by default it might send 5 notifications and if there is no acceptance after the fifth notification the HVAC control system 10 would return to step 50 and wait for the next event. Alternatively, the user may select any number of notifications to be sent before the HVAC control system 10 returns to step 50 if there is no acceptance by the user mobile phone 26. The user can also determine the timing of the delay between the resending of the notifications by the HVAC control system, this is a user changeable setting from a default delay time setting. For example, the user can set it to 10 seconds, 1 minute or any other period of time between resends.

Once the user mobile phone 26 has accepted the notification in step 70 the radio telematic control unit ECU 20 sends the user mobile phone 26 an authorization request asking if it is authorized to start the vehicle and turn on the HVAC system to adjust the internal temperature into the preferred predetermined temperature range in step 72. If the user through the user mobile phone 26 does not authorize turning on the vehicle and the HVAC system 28 in step 74 then the process moves to step 76 and ends. The user may not be going to the event that day, the time for the event may have changed, or the vehicle may be parked in a garage or somewhere else where the user does not want to have it running. As would be understood steps 68 and 72 could be combined into a single notification to the user mobile phone 26 indicating that the internal temperature is not within the preferred predetermined temperature range and requesting authorization to start the vehicle and turn on the HVAC system 28. Likewise steps 70 and 74 could be combined into a single response from the user mobile phone 26. If the user authorizes turning on the vehicle and HVAC system 28, then the system proceeds to step 80. Box 78 in FIG. 2B designates that the program continues in FIG. 2C at box 78.

In step 80 the radio telematic control unit ECU 20 sends a signal to the remote start module and ECU 22 to start the vehicle. The radio telematic control unit ECU 20 also sends a signal in step 82 to the vehicle HVAC system ECU 24 to turn on the HVAC system 28 and to set it to heating or cooling depending on where the internal temperature is relative to the preferred predetermined temperature range. In one embodiment, the radio telematic control unit ECU 20 also sends a signal to the user mobile phone 26 that the vehicle has been remote started and that the HVAC system has been turned on. In step 84 the HVAC system ECU 24 determines the heating or cooling degree depending on how much the temperature needs to be adjusted to be within the preferred predetermined temperature range and turns on the HVAC system 28. For example, if there is a 30-degree temperature difference between the internal temperature and the nearest end of the preferred predetermined temperature range this will required more temperature adjustment than if there is only 5 degrees. So, in the former case the HVAC system 28 may be turned on to air conditioning maximum cooling or heat maximum heating and a maximal fan speed. In the latter case the heating or cooling may be set to a mid-range with a mid-range fan speed.

Periodically, as indicated in step 86, while the HVAC system 28 is running, the infotainment system ECU 12 queries the temperature sensors 16 and compares the internal temperature to the preferred predetermined temperature range. Once the internal temperature reaches the preferred predetermined temperature range the process end in step 90. The radio telematic control unit ECU 20 sends a signal to the remote start module ECU 22 and turns the vehicle off. In addition, the radio telematic control unit ECU 20 sends a signal to the HVAC system ECU 24 and it turns off the HVAC system 28. Of course, if a user enters the vehicle while the process is running the user can interrupt the process at any time. Also, if the user enters the vehicle and moves the transmission out of park the process immediately ends. If the query by the infotainment system ECU 12 in step 88 indicates that the internal temperature is not within the preferred predetermined temperature range, then the HVAC control system 10 continues in the loop between steps 84, 86 and 88 until it is within the preferred predetermined temperature range. Alternatively, the HVAC control system 10 can be set up to skip steps 86 and 88, in which case it simply runs the HVAC system 28 until the normal remote start timeout time has been reached at which point the vehicle will turn off provided the user has not entered the vehicle before the timeout time and moved the vehicle transmission out of park.

The user interface 14 will allow a user to go into the HVAC control system 10 and modify any parameter at any time. For example, the user may be going on vacation and thus not want to receive notifications during this time. So the HVAC control system 10 may have a suspend feature wherein a user can choose a period of time during which the HVAC control system 10 is suspended and the program will not run at all without losing any of the entered event information.

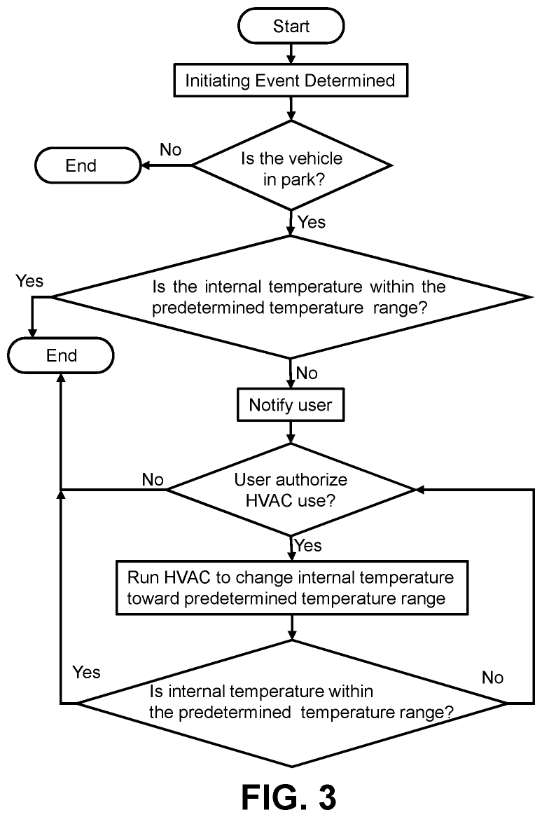

FIG. 3 shows a method in which, after an initiating event is determined, the system verifies that the vehicle is in a park mode or setting. The initiating event may be occurrence of the time for a predetermined event, which may include an event offset time, or a user command to turn on the HVAC system and/or remotely start the vehicle. The predetermined event may be provided by a user or learned by the control system and determined as a function of a user's routines or habits, as noted above, with the time, day and location of vehicle use being logged or monitored for re-occurrence of similar events based on at least these criteria. If the vehicle is not in park, the method may end.

If the vehicle is in park, then the method may continue to determine if the internal temperature of the vehicle is within a predetermined or user preferred temperature range. If the temperature is within the predetermined range, then no HVAC system use is needed to change the internal temperature and the method may end or the user may select an option to remote start the vehicle without requiring use of the HVAC system.

If the internal temperature is not within the predetermined temperature range, then the user may be notified, and if the user authorizes use of the HVAC system to alter the internal temperature, then the HVAC system may be activated to either heat or cool the vehicle interior. The method may recheck the internal temperature from time-to-time, as desired, and either allow the HVAC system to continue to run, or the user may be notified of the current internal temperature and be given the option to continue HVAC use or turn the system off. The loop may continue until the user denies authorization or the internal temperature reaches the predetermined temperature range.

The method of remotely adjusting a vehicle internal temperature using a vehicle HVAC system may thus include determining an occurrence of an initiating event, determining an internal temperature of a vehicle, sending a notification to a user when the internal temperature is outside of a predetermined temperature range, requesting authorization from the user to activate the HVAC system when the internal temperature is outside of the predetermined temperature range, and activating the HVAC system upon receipt of a user instruction to activate the HVAC system. The method may also include starting the vehicle after receipt of the user instruction.

The initiating event may be provided by a user, or learned by a control system based upon use of the vehicle, wherein the control system may track use of the vehicle with respect to time of day, day of week and vehicle location to determine one or more user habits or routines with regards to vehicle use. For example, a user may leave home to go to work at about the same time of day on various days of the week, and the determination of home and work locations may be accomplished by tracking vehicle location at points at which the vehicle is turned on and turned off. In this way, the system may receive and store user provided information relating to one or more initiating events, and/or system determined information relating to one or more initiating events.

The notification provided to a user may include information relating to one or more of the initiating events, time until the event is to occur, current internal temperature, and the notification may also include a request for instructions as to whether operate the HVAC system, start the vehicle or both.

System interaction between the user and vehicle may be accomplished with a remote device, such as a mobile phone, and via a wireless communication system, such as a cellular network and the vehicle telematic device, which communicates with a suitable controller or controllers of the vehicle. It is noted that while certain implementations are noted as having functions or method steps performed by an infotainment system ECU, other controllers or processors may be used instead of or in combination with an ECU that operates the infotainment system, and it is further noted that the infotainment system may be controlled by and/or communicated with by multiple ECUs, processors or controllers. Likewise, the other components noted as having ECUs may use one or more or be controlled by an ECU, processor or controller of another component. In other words, it is not necessary that each ECU noted be a separate or different ECU from other ECUs.

What is claimed is:

1. A method of remotely adjusting a vehicle internal temperature using a vehicle heating, ventilation, and air conditioning (HVAC) system comprising the steps of:
a. determining an occurrence of an initiating event;
b. determining an internal temperature of a vehicle;
C. sending a notification to a user when the internal temperature is outside of a predetermined temperature range;
d. requesting authorization from the user to activate the HVAC system when the internal temperature is outside of the predetermined temperature range; and
e. activating the HVAC system upon receipt of a user instruction to activate the HVAC system.

2. The method of claim 1 which also includes starting the vehicle after receipt of the user instruction.

3. The method of claim 1 wherein the initiating event is provided by a user.

4. The method of claim 1 wherein the initiating event is determined by a control system based upon use of the vehicle.

5. The method of claim 4 which also includes tracking use of the vehicle with respect to time of day, day of week and vehicle location to determine one or more user habits or routines with regards to vehicle use.

6. The method of claim 4 wherein the notification includes information relating to the initiating event.

7. The method of claim 1 which also includes redetermining the internal temperature after some time period after the activating step.

8. The method of claim 1 which includes providing at least one temperature sensor and a vehicle telematic unit, and wherein the step of determining the internal temperature is accomplished by querying the at least one temperature sensor, and wherein the notification and receipt steps are accomplished with the telematic unit.

9. The method of claim 2 which includes providing at least one temperature sensor, a vehicle telematic unit, and a remote start module, and wherein the step of determining the internal temperature is accomplished by querying the at least one temperature sensor, and wherein the notification and receipt steps are accomplished with the telematic unit, and wherein the step of starting the vehicle is accomplished by the remote start module.

10. The method of claim 1 which also includes receiving and storing user provided information relating to one or more initiating events.

11. The method of claim 10 which also includes providing a user interface for a vehicle infotainment system, and wherein the receiving step is accomplished via the user interface.

12. The method of claim 1 wherein the initiating event includes an event offset time of at least 5 minutes.

13. The method of claim 1 which also includes determining if the vehicle is in a park mode, and wherein the notification is not sent if the vehicle is not in the park mode.

14. The method of claim 1 wherein the predetermined temperature range is between 65 to 75° F., inclusive.

15. A vehicle heating, ventilation and air conditioning (HVAC) control system comprising:
a vehicle infotainment system including a user interface;
at least one temperature sensor connected to the infotainment system;
a vehicle telematic unit connected to the infotainment system and configured to communicate with a user mobile phone;
a vehicle HVAC system connected to the telematic unit;
a remote start module connected to the telematic unit and to the vehicle HVAC system; and
a vehicle transmission controller connected to the infotainment system, wherein the telematic unit is configured to wirelessly communicate with a user mobile phone and wherein the user mobile phone can, via the telematic unit, control the remote start module to start the vehicle, and can control the vehicle HVAC system to turn on the vehicle HVAC system.

16. The HVAC control system according to claim 15, wherein the vehicle transmission controller provides an output when the vehicle is not in a park mode to prevent actuation of the remote start module and remote actuation of the HVAC system via instructions received at the telematics unit.

17. The HVAC control system according to claim 15, wherein the at least one temperature sensor communicates an internal temperature of the vehicle to the infotainment system.
